(19) United States
(12) Patent Application Publication
(10) Pub. No.: US 2008/0248411 A1
(43) Pub. Date: Oct. 9, 2008

(54) Display Medium and Displaying Method

(75) Inventors: Masahiro Irie, Fukuoka (JP); Makoto Mihara, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignees: Masahiro IRIE, Fukuoka (JP); JSR Corporation, Chuo-ku (JP)

(21) Appl. No.: 11/547,165

(22) PCT Filed: Mar. 30, 2005
(86) PCT No.: PCT/JP2005/006091

§ 371 Date: Jun. 16, 2008

(30) Foreign Application Priority Data
Mar. 31, 2004 (JP) 2004-102949

(51) Int. Cl. B42D 15/10; B23K 26/00; B32B 27/16; G03C 1/76

(52) U.S. Cl. 430/10; 430/14; 430/56; 430/60; 219/121.85

(57) ABSTRACT

Provided are an indicating material having excellent facility and high security and an indicating method for recording and indicating information on this indicating material. The indicating material has a structure that an ultraviolet light-screening layer having visible light-transmitting ability is laminated on a recording layer having visible light-transmitting ability and composed of a recording layer-forming material containing a color-developing component that becomes a color-developed state by the action of ultraviolet light. The indicating method is an indicating method for recording and indicating information on the above-described indicating material, comprising condensing a laser beam having a wavelength of a visible range or longer on the recording layer in the indicating material to irradiate the recording layer with the laser beam and recording and indicating the information by two-photon absorption.

### TECHNICAL FIELD

The present invention relates to an indicating material and an indicating method for recording and indicating information on this indicating material.

### BACKGROUND ART

Prior art articles related to the present invention include, for example, the following articles:
Patent Art. 1: Japanese Patent Publication No. 11771/1986;
Patent Art. 2: Japanese Patent Publication No. 41320/1986;
Patent Art. 3: Japanese Patent Publication No. 59663/1987;
Patent Art. 4: Japanese Patent Application Laid-Open No. 192737/1986;
Patent Art. 5: Japanese Patent Publication No. 47314/1990;
Patent Art. 6: Japanese Patent Application Laid-Open No. 254743/1990;
Patent Art. 7: Japanese Patent Application Laid-Open No. 2002-273832;
Patent Art. 8: Japanese Patent Application Laid-Open No. 2002-309104;
Patent Art. 9: Japanese Patent Application Laid-Open No. 2003-255489;
Patent Art. 10: Japanese Patent Application Laid-Open No. 2003-308634;
Patent Art. 11: Japanese Patent Application Laid-Open No. 2003-64354;
Patent Art. 12: Japanese Patent Application Laid-Open No. 2000-256663; and
Patent Art. 13: Japanese Patent Application Laid-Open No. 2004-39009.

As an indicating material, has heretofore been used a portable type indicating material, in which information for identifying an individual owning this material is mainly recorded and indicated, such as a driver's license, passport or health insurance card. With the spreading and high advancement of an information-oriented society in recent years, it has been used as, for example, a credit card, cash card, security card or resident card, in which information for identifying an individual owning this card is recorded and indicated, or also as that, in which information for identifying a certain person is recorded and indicated, that, in which information recorded is rewritable, such as a magnetic card or IC card, or that, in which information for identifying a specifically produced lot product is recorded and indicated, such as an IC tag.

With the spreading of such indicating materials, they are required to have facility or convenience of permitting individually recording and indicating desired information in every indicating material or recording and indicating a great amount of information, and high security that forgery, falsification, alteration or damage of information recorded can be prevented.

In order to prevent the indicating material from being illegally used when it has passed into a third person by, particularly, loss, theft or the like, facial information of its owner has come to be indicated as one information on the indicating material. With the advancement of IT-oriented society in recent years, an indicating material, in which the so-called biometrix information such as fingerprint or iris has been stored as one information, has begun to be used in order to prevent another person in individual certification from impersonating its owner.

As a card-like indicating material used as such a portable type card, is widely used one generally produced by partitioning a sheet material having a surface area at least twice as much as the surface area of an indicating material to be produced into plural card-forming regions each having a size corresponding to the indicating material, recording the same information (hereinafter also referred to as “common information”) on each of these plural card-forming regions by, for example, an offset printing method or gravure printing method, cutting the sheet material into individual card-forming regions, recording personal information on the surface of each of the resultant cut portions, on which the common information has been recorded, by, for example, a silk printing method, ink-jet printing method or sublimate type thermal transfer printing method, and then subjecting the surface (hereinafter also referred to as “information recorded surface”), on which the common information and personal information have been recorded, to a laminating treatment with a transparent film or the like.

However, in the indicating material of such a structure, there is a possibility that the personal information recorded on the information recorded surface may be forged by, for example, separating the transparent laminated film to scratch out the personal information and newly recording another personal information, and so such an indicating material involves a problem that no sufficient security is obtained.

Recently, the so-called laser marker method (see, for example, Patent Art. 1 to Patent Art. 8) which is widely used in, for example, forming character indication of keys in various kinds of keyboards, comprising using, as an information recording member, a film of a multi-layer structure having, as an internal constructive layer, a resin layer containing an ink having the ability to absorb infrared light or visible light, and irradiating the resin layer with an infrared laser beam or visible laser beam to form a desired pattern has begun to be used for recording of personal information in a card-like indicating material.

In such an indicating material, high security that forgery, falsification, alteration or damage of information recorded can be prevented is achieved because the recording of the information is made on the resin layer located in the interior thereof. However, a quantity of information recorded is not always sufficient because indication of the information can be made with only a single color, and so the indicating material involves a problem that visibility of facial information or the like is poor.

### DISCLOSURE OF THE INVENTION

The present invention has been made on the basis of the foregoing circumstances and has as its object the provision of an indicating material having excellent facility and high security and an indicating method for recording and indicating information on this indicating material.

The indication material according to the present invention comprises a structure that an ultraviolet light-screening layer having visible light-transmitting ability is laminated on a recording layer having visible light-transmitting ability, and composed of a recording layer-forming material containing a color-developing component that becomes a color-developed state by the action of ultraviolet light.

The indication material according to the present invention features that the color-developing component making up the recording layer is substantially not faded from the color-developed state by the action of visible light.

In the indicating material according to the present invention, the color-developing component making up the recording layer may preferably be composed of a diarylethene derivative.

In the indicating material according to the present invention, the recording layer may preferably be composed of at least one of a yellow color-developing structural layer which develops a yellow color, a magenta color-developing structural layer which develops a magenta color, and a cyan color-developing structural layer which develops a cyan color.

The indicating material according to the present invention may have a recording layer composed of a plurality of color-developing structural layers, wherein the plurality of the color-developing structural layers contain respective color-developing components that each become a color-developed state by the action of ultraviolet light having the same wavelength, or may have a recording layer composed of a plurality of color-developing structural layers, wherein the plurality of the color-developing structural layers contain respective color-developing components that become a color-developed state by the action of ultraviolet light having different wavelengths.

The indicating material according to the present invention may preferably have a structure that the ultraviolet light-screening layer is laminated on one surface of the recording layer, and a black color recording layer composed of a black color-developing layer, which develops a black color, is laminated on the other surface of the recording layer.

The indicating material according to the present invention may preferably have a structure that the ultraviolet light-screening layer is laminated on one surface of the recording layer, and an opaque base layer is laminated on the other surface of the recording layer.

The indicating method according to the present invention is an indicating method for recording and indicating information on the above-described indicating material, which comprises condensing a laser beam having a wavelength of a visible range or longer on the recording layer in the indicating material to irradiate the recording layer with the laser beam and recording and indicating the information by two-photon absorption.

The indicating method according to the present invention may preferably comprise the step of conducting condensing and irradiation of the laser beam on at least one color-developing structural layer of the yellow color-developing structural layer, the magenta color-developing structural layer and the cyan color-developing structural layer, which form the recording layer.

As an indicating method according to the present invention for recording and indicating information on the indicating material of the structure having the recording layer composed of any one of color-developing structural layers of the yellow color-developing structural layer, the magenta color-developing structural layer and the cyan color-developing structural layer, the recording layer of the indicating material may be irradiated with light having a wavelength of 400 nm or shorter from a side opposite to the surface laminated on the ultraviolet light-screening layer in the recording layer, thereby recording and indicating the information.

The indicating method according to the present invention comprises irradiating the black color recording layer composed of the black color-developing layer in the indicating material with light having a wavelength of 500 nm or longer, thereby recording and indicating the information.

According to the indicating materials of the present invention, recording of information on the recording layer is made by chemically changing the color-developing component in the recording layer-forming material forming the recording layer, so that facility of permitting individually recording and indicating desired information in every indicating material is obtained, and high security that forgery, falsification, alteration or damage of information recorded can be prevented is achieved.

The recording layer is provided as that having the specific multi-layer structure, whereby information can be color-indicated, so that a quantity of recordable information can be increased to attain excellent visibility, and in turn far excellent security.

In addition, the indicating material is so constructed that the recording layer is provided as that having the specific multi-layer structure, and the black color recording layer composed of the black color-developing layer is laminated thereon, whereby information can be full color-indicated, so that a quantity of recordable information can be more increased to attain far excellent visibility, and in turn further excellent security.

According to the indicating method of the present invention, the color-developing component making up the recording layer in the indicating material can be chemically changed, thereby recording information on the indicating material and indicating it as a change of a color-developed state.

According to this indicating method, when the recoding layer has a multi-layer structure, desired information patterns can be surely formed on the respective color-developing structural layers making up the recording layer, so that the information can also be full color-indicated according to the so-called subtractive method by the combination of color developments related to these information patterns.

When the indicating material has the black color recording layer composed of the black color-developing layer, the mechanism of recording of information on the black color recording layer is different from the mechanism of recording of information on the recording layer, so that an information pattern formed on another layer is not changed due to the forming process of the information pattern on the black color-developing layer or recording layer, and so the information can be indicated in a desired state.

### BRIEF DESCRIPTION OF THE DRAWINGS

[FIG. 1] illustrates the construction of an exemplary indicating material according to the present invention.

[FIG. 2] illustrates the construction of another exemplary indicating material according to the present invention.

[FIG. 3] illustrates the construction of a further exemplary indicating material according to the present invention.

[FIG. 4] illustrates the construction of an exemplary apparatus used for recording and indicating information on an indicating material according to the present invention.

[FIG. 5] illustrates absorption spectrum atlases of a diarylethene derivative (1) in Synthesis Example 1 of Diarylethene Derivative.

[FIG. 6] illustrates absorption spectrum atlases of a diarylethene derivative (2) in Synthesis Example 2 of Diarylethene Derivative.

FIG. 7] illustrates absorption spectrum atlases of a diarylethene derivative (3) in Synthesis Example 3 of Diarylethene Derivative.

### DESCRIPTION OF CHARACTERS

1 Specific recording layer
1A, 1B, 1C Color-developing structural layer
2 Ultraviolet light-screening layer
3 Black color-developing layer
9 Opaque base layer
10 Specific indicating material
12 Two-photon laser beam source
13 Condenser lens
14 x-axis direction scan mirror
15 y-axis direction scan mirror
16 Supporting table

### BEST MODE FOR CARRYING OUT THE INVENTION

The present invention will hereinafter be described in detail.

The indicating material according to the present invention is a laminate having a structure that an ultraviolet light-screening layer having visible light-transmitting ability is laminated on a recording layer (hereinafter also referred to as “specific recording layer”) having visible light-transmitting ability and composed of a recording layer-forming material containing a color-developing component that becomes a color-developed state by the action of ultraviolet light.

In the present description, “ultraviolet light” means light having a wavelength of 200 to 400 nm, and “visible light-transmitting ability” means the ability that the total light transmittance in a visible range is at least 70%.

As examples of preferred embodiments of the indicating material according to the present invention, may be mentioned indicating materials (hereinafter also referred to as “specific indicating materials”) having any one of the following constructions (1) to (3):
(1) An indicating material (hereinafter also referred to as “specific single color indicating material”) of the construction formed by an opaque base layer 9, a specific recording layer 1 formed on this opaque base layer 9 and an ultraviolet light-screening layer 2 laminated on one surface (upper surface in FIG. 1) of the specific recording layer 1 as illustrated in FIG. 1, wherein the specific recording layer 1 has a single-layer structure composed of only one of a yellow color-developing structural layer which develops a yellow color, a magenta color-developing structural layer which develops a magenta color, and a cyan color-developing structural layer which develops a cyan color.
(2) An indicating material (hereinafter also referred to as “specific multi color indicating material”) of the construction formed by an opaque base layer 9, a specific recording layer 1 formed on this opaque base layer 9 and an ultraviolet light-screening layer 2 laminated on one surface (upper surface in FIG. 2) of the specific recording layer 1 as illustrated in FIG. 2, wherein the specific recording layer 1 has a multi-layer structure obtained by laminating at least two color-developing structural layers (two color-developing structural layers 1A and 1B in FIG. 2) of the yellow color-developing structural layer, the magenta color-developing structural layer and the cyan color-developing structural layer.
(3) An indicating material (hereinafter also referred to as “specific black color indicating material”) of the construction formed by an opaque base layer 9, a specific recording layer 1 formed over this opaque base layer 9, an ultraviolet light-screening layer 2 laminated on one surface (upper surface in FIG. 3) of the specific recording layer 1 and a black color recording layer 3 laminated on the other surface (lower surface in FIG. 3) of the specific recording layer 1 and composed of a black color-developing structural layer, which develops black, as illustrated in FIG. 3, wherein the specific recording layer 1 has a structure composed of at least one color-developing structural layer (three color-developing structural layers 1A, 1B and 1C in FIG. 3), of the yellow color-developing structural layer, the magenta color-developing structural layer and the cyan color-developing structural layer.

Each specific indicating material preferably has a thickness of 0.1 to 2 mm (100 to 2,000 μm), particularly preferably 0.2 to 1 mm (200 to 1,000 μm).

If the thickness is smaller than 0.1 mm, the mechanical strength of such an indicating material becomes insufficient. In addition, there is a possibility that positioning accuracy in a thickness-wise direction (a vertical direction in FIGS. 1 to 3) of the specific indicating material to a position irradiated with a laser beam in an indicating method, which will be described subsequently, may not be sufficiently attained. If the thickness is greater than 2 mm on the other hand, there is a possibility that defects such as breakage and chipping may occur upon a cutting process in a working step for providing the specific indicating material as a card, which will be described subsequently.

The thickness of each of the yellow color-developing structural layer, the magenta color-developing structural layer and the cyan color-developing structural layer making up the specific recording layer is preferably 10 to 500 μm, particularly preferably 50 to 300 μm.

If the thickness of each color-developing structural layer is smaller than 10 μm, the contrast of information recorded and indicated on the resulting indicating material becomes insufficient. In addition, there is a possibility that positioning accuracy in a thickness-wise direction (a vertical direction in FIGS. 1 to 3) of the specific indicating material to a position irradiated with a laser beam in an indicating method, which will be described subsequently, may not be sufficiently attained, and so desired information may not be recorded. If the thickness of each color-developing structural layer exceeds than 500 μm on the other hand, an amount of the color-developing component required to attain a desired indicated state on the specific indicating material is increased, and so production cost is expensive.

In the specific indicating material, the thickness of the black color-developing layer making up the black color recording layer is preferably 0.1 to 0.3 mm (100 to 300 μm), particularly preferably 0.15 to 0.2 mm (150 to 200 μm).

In the specific indicating material, no limitation is imposed on the thickness of the ultraviolet light-screening layer so far as it can substantially cut off ultraviolet light.

No limitation is also imposed on the thickness of the opaque base layer so far as it is substantially not transparent. However, the opaque base layer can preferably cut off ultraviolet light.

On such a specific indicating material, may be laminated another functional layer such as an IC memory layer equipped with, for example, an IC memory element, or a printing layer for recording common information by a printing method, for example, a gravure printing method, offset printing method or silk printing method. Alternatively, a hard-coated layer or a reflection-preventing layer may also be laminated on the surface thereof, specifically, for example, the surface of the ultraviolet light-screening layer or the surface of the opaque base layer.

The surface of the specific indicating material may be subjected to an embossing treatment in that an effect to relieve the fatigue of eyes due to seeing the information recorded on the specific indicating material is brought about.

The recording layer-forming material (hereinafter also referred to as “specific recording layer-forming material”) making up each color-developing structural layer in the specific recording layer of such a specific indicating material is composed of a resin binder and a color-developing component contained in this binder.

Incidentally, additives, for example, a parting agent, a stabilizer, an antioxidant and a reinforcing agent, may be added to the recording layer-forming material as needed.

As the resin binder, is preferred a transparent resin, and examples thereof include polyethylene resins, ionomer resins, polypropylene resins, polymethylpentene resins, polyethylene terephthalate resins, polycyclohexane-1,4-dimethylterephthalate (PCT) resins, polybutylene terephthalate resins, polyethylene naphthalate resins, polyglycolic acid resins, polystyrene resins, rubber-reinforced styrene resins, for example, AS resins, ABS resins, MABS resins and AAS resins, vinyl chloride resins, polymethyl methacrylate resins, polycarbonate resins, phenol resins, cycloolefin resins, acrylic resins, urethane resins, epoxy resins, norbornene resins, polyarylate resins, and polyimide resins.

These resins may be used either singly or in any combination thereof.

A proportion of the color-developing component contained in this resin binder is preferably 0.1 to 5% by mass based on 100% by mass of the resin binder.

Examples of the color-developing component include diarylethene derivatives, flugide derivatives and phenoxynaphthacene derivatives.

Among these derivatives, diarylethene derivatives are preferred in that color-developed state is not substantially faded by the action of visible light and are hard to be faded by the action of heat.

Specifically, examples of diarylethene derivatives preferably used as color-developing components include compounds represented by the following general formula (1A) and general formula (2A).

[Chemical Formula 1]

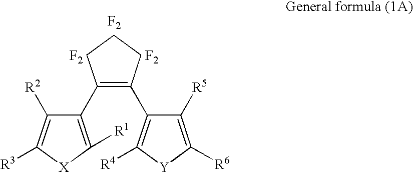

In the formula, R¹ and R⁴ individually mean an alkoxy group, R², R³, R⁵ and R⁶ denote, independently of one another, a monovalent group, and X and Y represent, independently of each other, an atom selected from an oxygen atom, a sulfur atom and a carbon atom.]

[Chemical Formula 2]

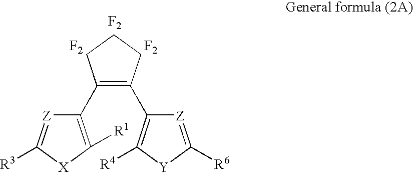

In the formula, R¹ and R⁴ individually mean an alkoxy group, R³ and R⁶ denote, independently of each other, a monovalent group, X and Y represent, independently of each other, an atom selected from an oxygen atom, a sulfur atom and a carbon atom, and Z denotes a carbon atom or nitrogen atom.]

In the general formula (1A) and general formula (2A), each of R³ and R⁶ is preferably a group composed of an aromatic hydrocarbon ring or aromatic heterocyclic ring, or a combined group of a polyethylene group or polyacetylene group and a group composed of an aromatic hydrocarbon ring or aromatic heterocyclic ring because the derivative preferably has a structure that conjugation extends from both hetero-aryl rings of the diarylethene structure to R³ and R⁶, respectively.

In the general formula (1A), each of R² and R⁵ is preferably a hydrogen atom, alkyl group, alkoxy group, halogen atom, alkyl fluoride group, cyano group or aryl group.

Each of the diarylethene derivatives represented by the general formula (1A) and general formula (2A) is changed from a colorless ring-opening compound represented by the general formula (1A) or general formula (2A) to a ring-closing compound represented by the following general formula (1B) or general formula (2B) by the action of ultraviolet light and is converted to a color-developed state.

The general formula (1B) represents a ring-closing compound of the diarylethene derivative represented by the general formula (1A), while general formula (2B) represents a ring-closing compound of the diarylethene derivative represented by the general formula (2A).

[Chemical Formula 3]

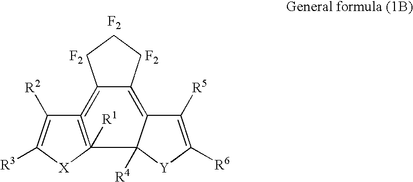

[In the formula, R¹ and R⁴ individually mean an alkoxy group, R², R³, R⁵ and R⁶ denote, independently of one another, a monovalent group, and X and Y represent, independently of each other, an atom selected from an oxygen atom, a sulfur atom and a carbon atom.]

[Chemical Formula 4]

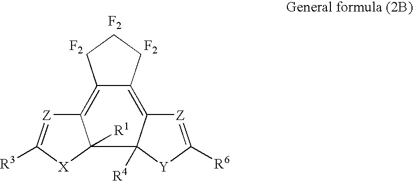

In the formula, R¹ and R⁴ individually mean an alkoxy group, R³ and R⁶ denote, independently of each other, a monovalent group, X and Y represent, independently of each other, an atom selected from an oxygen atom, a sulfur atom and a carbon atom, and Z denotes a carbon atom or nitrogen atom.]

As a diarylethene derivative used as a color-developing component (hereinafter also referred to as “yellow color-developing component”) for making up a yellow color-developing structural layer, is mentioned a compound represented by the following general formula (3A).

The diarylethene derivative represented by the general formula (3A) is changed to a ring-closing compound represented by the following general formula (3B) by the action of ultraviolet light and is converted to a color-developed state.

[Chemical Formula 5]

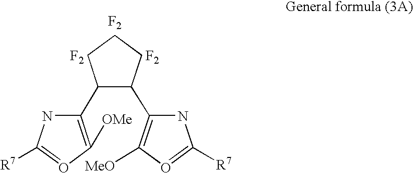

In the formula, R⁷ means a phenyl group which may be substituted.]

[Chemical Formula 6]

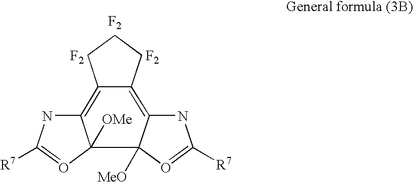

[In the formula, R⁷ means a phenyl group which may be substituted.]

Specific examples of the diaryl derivative represented by the general formula (3A) include 1,2-bis(5-methoxy-2-phenyloxazol-4-yl)perfluorocyclo-pentene.

These compounds may be use either singly or in any combination thereof.

As a diarylethene derivative used as a color-developing component (hereinafter also referred to as “magenta color-developing component”) for making up a magenta color-developing structural layer, is mentioned a compound represented by the following general formula (4A).

The diarylethene derivative represented by the general formula (4A) is changed to a ring-closing compound represented by the following general formula (4B) by the action of ultraviolet light and is converted to a color-developed state.

[Chemical Formula 7]

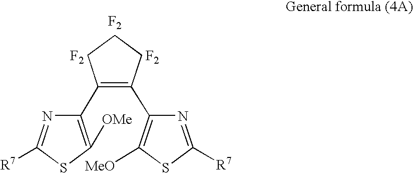

In the formula, R⁷ means a phenyl group which may be substituted.]

[Chemical Formula 8]

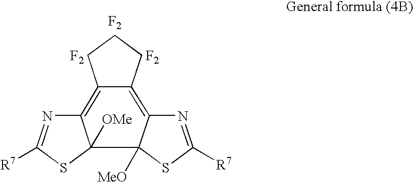

In the formula, R⁷ means a phenyl group which may be substituted.]

Specific examples of the diaryl derivative represented by the general formula (4A) include 1,2-bis(5-methoxy-2-phenylthiazol-4-yl)perfluorocyclo-pentene, 1,2-bis(1-phenyl-4-methoxy-3-thiazoyl)-perfluorocyclopentene and 1,2-bis(1-(1′-methoxy-phenyl)-4-methoxy-3-thiazoyl)perfluorocyclopentene.

These compounds may be use either singly or in any combination thereof.

As a diarylethene derivative used as a color-developing component (hereinafter also referred to as “cyan color-developing component”) for making up a cyan color-developing structural layer, is mentioned a compound represented by the following general formula (5A).

The diarylethene derivative represented by the general formula (5A) is changed to a ring-closing compound represented by the following general formula (5B) by the action of ultraviolet light and is converted to a color-developed state.

[Chemical Formula 9]

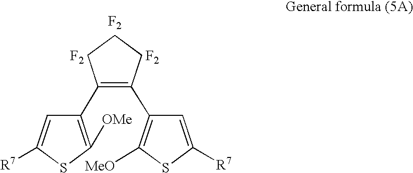

In the formula, R⁷ means a phenyl group which may be substituted.]

[Chemical Formula 10]

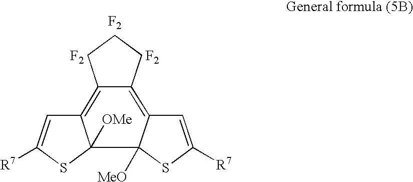

In the formula, R⁷ means a phenyl group which may be substituted.]

Specific examples of the diaryl derivative represented by the general formula (5A) include 1,2-bis(2-methoxy-5-phenylthiophen-3-yl)perfluorocyclo-pentene, 1,2-bis(5-phenyl-2-methoxy-3-thienyl)-perfluorocyclopentene and 1,2-bis(5-(1′-methoxy-phenyl)-2-methoxy-4-thienyl)perfluorocyclopentene.

These compounds may be use either singly or in any combination thereof.

No particular limitation is imposed on the ultraviolet light-screening layer so far as it has a visible light-transmitting ability and at the same time, an ultraviolet light-screening function that the color-developing component making up the specific recording layer is prevented from being chemically changed by irradiating the specific recoding layer with ultraviolet light to become a color-developed state. For example, a film composed of a material having ultraviolet light-absorbing ability, or a film coated with a coating agent containing an ultraviolet light absorber may be used. Alternatively, a coating film composed of a coating agent containing an ultraviolet light absorber may also be directly formed on the surface of the specific recording layer to provide it as the ultraviolet light-screening layer, or an ultraviolet light absorber may also be directly deposited on the surface of the specific recording layer by a vapor. deposition method or the like to provide the resultant deposited film as the ultraviolet light-screening layer.

As a material for forming the film composed of the material having the ultraviolet light-absorbing ability, may be mentioned, for example, that composed of a resin binder and an ultraviolet light absorber contained therein.

As the ultraviolet light absorber, may be used, for example, an inorganic ultraviolet light absorber such as ultrafine particles composed of zinc oxide, titanium oxide or the like, or an organic ultraviolet light absorber of a benzotriazole type, triazine type, benzophenone type or the like.

As the coating agent containing the ultraviolet light absorber, may be used, for example, that obtained by mixing a coating liquid composed of an acrylic emulsion or a low-molecular weight thermosetting urethane acrylate, and a catalyst or the like with the ultraviolet light absorber according to a wet dispersing and mixing method.

In the ultraviolet light-screening layer, the ultraviolet light-screening rate is preferably at least 90%, more preferably at least 95%, particularly preferably at least 98%.

If the ultraviolet light-screening rate is lower than 90%, a sufficient ultraviolet light-screening function is not attained in the ultraviolet light-screening layer, and there is a possibility that color development may occur at other portions than a portion where information is recorded and indicated in the specific indicating material, thereby lowering information-distinguishing ability.

The black color recording layer is composed of a black color recording layer-forming material containing a color-developing component (hereinafter also referred to as “black color-developing component”) composed of an energy absorber, which becomes a black color-developed state by the action of a laser beam of visible light or the like. When this black color recording layer is substantially not transparent in a state that no information has been recorded or indicated, it may also function as an opaque base layer. Further, when an ultraviolet light absorber is contained, it may also function as an ultraviolet light-screening layer.

On this black color recording layer, information (generally, common information) may also be recorded in other regions than a region where information should be recorded and indicated by a method, which will be described subsequently, by any of various printing methods, for example, a gravure printing method, offset printing method and silk printing method.

The black color recording layer-forming material making up this black color recording layer is composed of a resin binder and a black color-developing component contained therein.

Incidentally, additives, for example, a parting agent, a stabilizer, an antioxidant and a reinforcing agent, may be added to the black color recording layer-forming material as needed.

Examples of the resin binder include those exemplified as the resin binder making up the specific recording layer-forming material.

These may be used either singly or in any combination thereof.

A proportion of the black color-developing component contained in this resin binder is preferably 0.5 to 7% by mass, particularly preferably 1 to 5% by mass based on 100% by mass of the resin binder.

If the proportion of the black color-developing component contained is lower than 0.5% by mass, the opacity required for the black color recording layer as the opaque base layer cannot be sufficiently achieved. If the proportion of the black color-developing component contained exceeds 7% by mass on the other hand, the light transmittance of the black color recording layer is reduced to lower than 50%, so that there is a possibility that sufficient color-developing ability may not be obtained.

Examples of the black color-developing component include carbon black, metal oxides such as titanium oxide and zinc oxide (zinc white), metal sulfides such as zinc sulfide, carbonates such as calcium carbonate, and metal silicates such as magnesium silicate and talc.

These may be used either singly or in any combination thereof

As carbon black, is preferably used that having an average particle diameter of 12 to 125 nm and a dibutyl terephthalate oil absorption of 60 to 170 mL/100 g.

Specific preferable examples of the black color-developing component include mixtures of carbon black and one of titanium oxide, zinc sulfide and magnesium silicate or a combination (hereinafter also referred to as “specific inorganic substance”) of at least two compounds thereof. A mixing ratio (carbon black to the specific inorganic substance) between them is preferably 0.0009:0.8 to 0.0012:1.3, particularly preferably 0.001:1.0.

The opaque base layer has a function that color development in the specific recording layer and the black color recording layer can be made conspicuous, and the color-developing component making up the specific recording layer, on which information has been recorded, is prevented from being chemically changed by irradiating the specific recoding layer with ultraviolet light to become a color-developed state, and preferably shows a white color as a whole like, for example, white paper.

On this opaque base layer, information (generally, common information) may also be recorded by any of various printing methods, for example, a gravure printing method, offset printing method and silk printing method.

An opaque base layer-forming material making up the opaque base layer is composed of a resin binder and an opacifying agent contained therein.

Incidentally, additives, for example, a parting agent, a stabilizer, an antioxidant and a reinforcing agent, may be added to the opaque base layer-forming material as needed.

Examples of the resin binder include those exemplified as the resin binder making up the specific recording layer-forming material.

These may be used either singly or in any combination thereof.

A proportion of the opacifying agent contained in this resin binder is preferably 5 to 30% by mass based on 100% by mass of the resin binder.

If the proportion of the opacifying agent contained is lower than 5% by mass, the opacity required cannot be sufficiently achieved. If the proportion of the opacifying agent contained exceeds 30% by mass on the other hand, flexibility of the resulting indicating material is lowered and becomes brittle, and production cost is expensive.

Examples of the opacifying agent include silica, calcium carbonate, alumina, talc, satin white, rutile type titanium oxide and hollow organic particles.

These may be used either singly or in any combination thereof.

As the base, may be use any of the resins exemplified as the resin binder making up the specific recording layer-forming material.

In the specific indicating material of the above-described construction, each of the color-developing structural layers in the specific recording layer is irradiated with a focused beam obtained by condensing a laser beam (hereinafter also referred to as “specific laser beam”) having a wavelength of a visible range or longer, which is emitted from an apparatus equipped with an ultra-short pulse laser beam source (hereinafter also referred to as “two-photon laser beam source”) of high power and nanoseconds or femtoseconds, such as a titanium sapphire crystal laser, by a condensing lens, whereby information is recorded by two-photon absorption occurred only in the vicinity of a focus position where a focal point in the focused beam is located, and the information recorded is indicated as a change of a color-developed state.

Here, “two-photon absorption” is a sort of non-linear optical phenomenon that absorption corresponding to energy twice as much as the irradiation beam is caused by absorbing 2 photons at the same time and has characteristics that the probability of the occurrence is proportional to a square of the intensity of the irradiation beam. In this two-photon absorption, energy per one-photon amounts to twice as much as energy in ordinary absorption (one-photon absorption), i.e., the frequency related to the irradiation beam is increased to twice, and the wavelength is reduced to one half. However, in the specific indicating material in a state irradiated with the specific laser beam condensed, a color-developing reaction of the color-developing component in the recording layer-forming material making up the color-developing structural layer is induced in the vicinity of the focus position because the specific laser beam does not have a wavelength, by which the color-developing component in the recording layer-forming material making up the color-developing structural layer is brought into a color-developed state, and the two-photon absorption locally occurs only in the vicinity of the focus position in a region irradiated with the focused beam.

Specifically, in order to record and indicate information on the specific indicating material, it is necessary to individually irradiate the respective color-developing structural layers (specifically, yellow color-developing structural layer, magenta color-developing structural layer and cyan color-developing structural layer) making up the specific recording layer of the specific indicating material with a condensed beam. As an indicating method for it, may be used, for example, a method comprising using an apparatus having such a construction as shown below and repeating beam condensing and irradiation while changing the focus position of the focused beam.

FIG. 4 illustrates the construction of an exemplary apparatus used for recording and indicating information on the specific indicating material.

This information recording apparatus has a construction that a specific indicating material, on which information is to be recorded and indicated, is supported by a supporting table 16 movable in a direction of an optical axis (vertical direction in FIG. 4, hereinafter also referred to as “z-axis direction”) of a specific laser beam emitted from a two-photon laser beam source 12, the specific laser beam from the two-photon laser beam source 12 is struck on a condensing lens 13 through an x-axis direction scan mirror 14 composed of a galvanomirror and a y-axis direction scan mirror 15 composed of a galvanomirror, thereby condensing the laser beam, and the specific indicating material 10 in the state supported by the supporting table 16 is irradiated with the condensed laser beam.

In this information recording apparatus, “the x-axis direction scan mirror” and “the y-axis direction scan mirror” (hereinafter, both may also be referred to as “xy-axes direction scan mirrors” collectively) have functions for scanning the focus position to a left-right direction (hereinafter also referred to as “x-axis direction) and a forward-backward direction (hereinafter also referred to as “y-axis direction) in FIG. 3, respectively.

Such an information recording apparatus serves to record information by condensing the specific laser beam from the two-photon laser beam source 12 by the condensing lens 13 and irradiating the respective color-developing structural layers making up the specific recording layer in the specific indicating material 10 mounted on the supporting table 16 with the focused beam. The supporting table 16 is moved, thereby controlling a position in a z-axis direction of the focal point in the focused beam, and positions of in an x-axis direction and a y-axis direction of the-focal point in the focused beam are controlled by the xy-axes direction scan mirrors, respectively, whereby desired information patterns can be formed on the respective color-developing structural layers in the specific recording layer.

Specifically, according to the information recording apparatus of such a construction, a beam condensing and irradiating treatment that the specific indicating material 10 mounted on the supporting table 16 is irradiated with the focused beam of the beam emitted from the two-photon laser beam source 12 and condensed by the condensing lens 13 in such a manner that a focal point is always located at one color-developing structural layer making up the specific recording layer is conducted repeatedly while moving the focus position to the x-axis direction and the y-axis direction in the color-developing structural layer by the x-axis direction scan mirror 14 and the y-axis direction scan mirror 15, thereby forming information patterns corresponding to information to be indicated, and the supporting table 16 is then moved, thereby locating the focal point of the focused beam in another color-developing structural layer making up the specific recording layer to conduct the beam condensing and irradiating treatment and form information patterns, whereby desired information can be recorded and indicated on the specific indicating material 10.

According to this information recording apparatus, the desired information can also be recorded and indicated on the specific indicating material 10 by irradiating the specific indicating material 10 mounted on the supporting table 16 with the focused beam of the beam emitted from the two-photon laser beam source 12 and condensed by the condensing lens 13 while moving the focus position in the z-axis direction by the supporting table 16 in a state that the irradiation positions of the focused beam in the x-axis direction and the y-axis direction have been fixed, and then changing and fixing the irradiation positions of the focused beam in the x-axis direction and the y-axis direction to repeatedly conduct the beam condensing and irradiating treatment that the specific indicating material 10 is irradiated with the focused beam in the thickness-wise direction thereof.

As an information recording apparatus used for recording and indicating information on the specific indicating material, may also be used an apparatus of a construction having a mechanism that the specific indicating material 10 mounted on the supporting table is freely moved in the x-axis direction, y-axis direction and z-axis direction in place of the mechanism that the focal point of the focused beam struck on the respective color-developing structural layers making up the specific recording layer in the specific indicating material 10 is moved.

In such an information recording apparatus as described above, the formation of information patterns on respective color-developing structural layers can be conducted by only one two-photon laser beam source when the specific indicating material is made up by at least two color-developing structural layers, and the respective color-developing structural layers respectively contain color-developing components brought into a color-developed state by the action of ultraviolet light having the same wavelength.

On the other hand, when the specific indicating material is made up by at least two color-developing structural layers, and the respective color-developing structural layers respectively contain color-developing components brought into a color-developed state by the action of ultraviolet light having different wavelengths, the respective color-developing structural layers are combined paying attention in such a manner that a wavelength range facilitating color development does not overlap a wavelength range facilitating fading in relation between the respective color-developing structural layers, and laser beam sources corresponding to the respective color-developing structural layers are used, or a laser beam source having a wavelength-variable mechanism is used, whereby information patterns to the respective color-developing structural layers can be formed.

In the specific single color indicating material, information may also be recorded by using a laser apparatus emitting a laser beam (ultraviolet light) having a wavelength of 400 nm or shorter, preferably 300 to 400 nm or an apparatus obtained by combining a liquid crystal shutter with an ultraviolet lamp and irradiating the specific recording layer making up the specific single color indicating material with the laser beam through no ultraviolet light-screening layer from a side opposite to the surface laminated on the ultraviolet light-screening layer in the recording layer.

Such a specific single color indicating material is preferably produced by first forming a laminate of the specific recording layer and the ultraviolet light-screening layer, recording information on the specific recording layer and then laminating the opaque base layer on a surface opposite to the surface laminated on the ultraviolet light-screening layer in the specific recording layer. By going through such a production process, it can be prevented to lower the distinguishing ability of the indicating material itself due to color development at other portions than a portion where information is recorded and indicated by causing the ultraviolet light to act on the specific recording layer from the side opposite to the surface laminated on the ultraviolet light-screening layer. In addition, contrast of the recorded and indicated information is improved by the opaque base layer to attain high visibility.

When the information is recorded and indicated on the specific indicating material by such a method as described above, the irradiation time and irradiation intensity of the irradiating laser beam are controlled, whereby the indicated state of the information to be indicated can be controlled.

In the specific black color indicating material, an information pattern corresponding to information to be indicated is formed on the specific recording layer by the method utilizing the action of the above-described two-photon absorption. However, an information pattern corresponding to information to be indicated is formed on the black color recording layer by irradiating the black color recording layer with light having a wavelength of 500 nm or longer, preferably 532 to 1,064 nm through no opaque base layer from a side opposite to the surface laminated on the specific recording layer in the black color recording layer.

As an apparatus used for forming the information pattern on the black color recording layer, is preferably used, for example, an apparatus in which a YAG laser element (monocrystal of yttrium aluminum garnet to which a minute amount of neodymium is added), whose oscillation wavelength is 1,064 nm, or neodymium-yttrium vanadium tetraoxide, whose oscillation wavelength is 532 to 1,064 nm, is used as a laser medium, a laser beam is a single mode, and a beam diameter is 20 to 100 μm.

Such a specific indicating material is preferably used as various portable cards. A card-like specific indicating material (hereinafter also referred to as “card type specific indicating material”) can be produced in accordance with, for example, any of the following methods (1) to (3).
(1) A method comprising forming a multi-layer sheet material having a surface area at least twice as much as the surface area of a card type specific indicating material to be produced, in which an opaque base layer, a specific recording layer and an ultraviolet light-screening layer are laminated in this order, and a black color recording layer is formed between the opaque base layer and the specific recording layer as needed, partitioning the multi-layer sheet material into plural card-forming regions each having a size corresponding to the card type specific indicating material to be produced, recording desired personal information and common information on the specific recording layer and the black color recording layer formed as needed in each of these plural card-forming regions by conducting a desired laser beam irradiation treatment from a side of the ultraviolet light-screening layer, and subjecting the multi-layer sheet material, on which the personal information and common information have been recorded and indicated, to a working step including a cutting process that the sheet material is cut into individual card-forming regions, thereby producing card type specific indicating materials.
(2) A method comprising forming a sheet material for opaque base layer having a surface area at least twice as much as the surface area of a card type specific indicating material to be produced, partitioning the sheet material for opaque base layer into plural card-forming regions each having a size corresponding to the card type specific indicating material to be produced, recording common information on each of these plural card-forming regions by, for example, a gravure printing method, offset printing method or silk printing method, subjecting the sheet material for opaque base layer in a state that the common information has been recorded to a lamination treatment with a multi-layer sheet material obtained by laminating a specific recording layer and an ultraviolet light-screening layer each having a surface area at least twice as much as the surface area of the card type specific indicating material to be produced and additionally laminating a black color recording layer on a surface opposite to the surface laminated on the ultraviolet light-screening layer in the specific recording layer as needed, recording desired personal information on the specific recording layer and as needed, the black color recording layer in each of card-forming regions of the resultant laminated material by a desired laser beam irradiation treatment or an ultraviolet lamp irradiation treatment using a liquid crystal shutter as a mask from a side of the ultraviolet light-screening layer, and subjecting the laminated material, on which the personal information and common information have been recorded and indicated, to a working step including a cutting process that the laminated material is cut into individual card-forming regions, thereby producing card type specific indicating materials.
(3) A method comprising forming a sheet material for opaque base layer having a surface area at least twice as much as the surface area of a card type specific indicating material to be produced, partitioning the sheet material for opaque base layer into plural card-forming regions each having a size corresponding to the card type specific indicating material to be produced, recording common information on each of these plural card-forming regions by, for example, a gravure printing method, offset printing method or silk printing method, on the other hand, forming a multi-layer sheet material, in which a specific recording layer and an ultraviolet light-screening layer each having a surface area at least twice as much as the surface area of the card type specific indicating material to be produced are laminated, and a black color recording layer is additionally laminating on a surface opposite to the surface laminated on the ultraviolet light-screening layer in the specific recording layer as needed, also partitioning the multi-layer sheet material into plural card-forming regions, recording desired personal information on the specific recording layer and as needed, the black color recording layer in each of these card-forming regions by a desired laser beam irradiation treatment from a side opposite to the surface laminated on the ultraviolet light-screening layer, conducting a lamination treatment in such a manner that the multi-layer sheet material in a state that the personal information has been recorded is laminated on the printed surface of the sheet material for opaque base layer, and subjecting the resultant laminated material to a working step including a cutting process that the laminated material is cut into individual card-forming regions, thereby producing card type specific indicating materials.

When a card type specific indicating material having a black color recording layer which also functions as an opaque base layer is produced in the method (3), a sheet material for black color recording layer is formed in place of the sheet material for opaque base layer, this sheet material for black color recording layer is laminated on the multi-layer sheet material in a state that the specific recording layer and ultraviolet light-screening layer have been laminated and the personal information has been recorded, desired common information is recorded on the black color recording layer in each of the card-forming regions of the resultant laminated material by a desired laser beam irradiation treatment, and the laminated material, on which the personal information and common information have been recorded and indicated, is subjected to a working step including a cutting process that the laminated material is cut into individual card-forming regions, whereby card type specific indicating materials can be produced.

In each of the methods (1) to (3), the cutting process comprising cutting into individual card-forming regions may also be conducted before personal information is recorded to record the personal information on each of the card type specific indicating materials obtained by the cutting.

A card type specific indicating material, on which an IC memory layer is laminated, can be produced by forming a multi-layer sheet material having an IC memory layer in the method (1), or by forming a multi-layer sheet material having an IC memory layer and an opaque base layer in place of the sheet material for opaque base layer in the methods (2) and (3).

Here, the multi-layer sheet material (hereinafter also referred to as “specific multi-layer sheet material”), in which a specific recording layer and an ultraviolet light-screening layer are laminated, and a black color recording layer and/or an opaque base layer is laminated as needed, is formed in the following manner.

Each of a yellow color-developing component, a magenta color-developing component and a cyan color-developing component is evenly mixed with a resin binder in advance by a Henschel mixer or the like, and this mixture is granulated or pelletized by means of an extruder and a pelletizer to prepare a specific recording layer-forming material (hereinafter also referred to as “pellets for specific recording layer).

An ultraviolet light absorber is also evenly mixed with a resin binder by a Henschel mixer or the like, and this mixture is granulated or pelletized by means of an extruder and a pelletizer to prepare an ultraviolet light-screening layer-forming material (hereinafter also referred to as “pellets for ultraviolet light-screening layer). As needed, a black color-developing component is evenly mixed with a resin binder by a Henschel mixer or the like and this mixture is granulated or pelletized by means of an extruder and a pelletizer to prepare a black color recording layer-forming material (hereinafter also referred to as “pellets for black color recording layer).

As needed, an opacifying agent is evenly mixed with a resin binder by a Henschel mixer or the like and this mixture is granulated or pelletized by means of an extruder and a pelletizer to prepare an opaque base layer-forming material (hereinafter also referred to as “pellets for opaque base layer).

The pellets for specific recording layer and pellets for ultraviolet light-screening layer, and the pellets for black color recording layer and pellets for opaque base layer as needed are used as forming material, and these plural kinds of forming materials are co-extruded on a base sheet material under conditions of a melt extruding temperature of 150 to 300° C., preferably 200 to 280° C. by means of a melt extruding apparatus equipped with a multi T-die, thereby forming a multi-layer sheet material having a desired laminated state.

The specific multi-layer sheet material may also be obtained by a method in which the pellets for specific recording layer, the pellets for ultraviolet light-screening layer and the pellets for opaque base layer, and the pellets for black color recording layer as needed are respectively dissolved in their proper solvents, single-layer sheets are formed from these solutions by a solvent casting process, and these sheets are laminated on one another.

The specific recording layer in the specific multi-layer sheet material may also be obtained by a method in which color-developing components (specifically, yellow color-developing component, magenta color-developing component and cyan color-developing component) are respectively dissolved together with a resin binder in their proper solvents, single-layer sheets are formed from these solutions by a solvent casting process, and these sheets are laminated on one another.

According to such a specific indicating material as described above, recording of information on the specific recording layer is made by chemically changing the color-developing components in the recording layer-forming materials forming the specific recording layer, so that facility of permitting individually recording and indicating desired information in every indicating material is obtained. In addition, each of the color-developing structural layers forming the specific recording layer and each having a predetermined thickness is brought into a color-developed state in the whole thickness-wise direction thereof, thereby forming an information pattern corresponding to information to be indicated to record the information, so that the information is difficult to be deleted by, for example, scratching. As a result, high security that forgery, falsification, alteration or damage of the information recorded can be prevented is achieved.

The specific recording layer is provided as a layer having the specific multi-layer structure, whereby information can be color-indicated by surely forming desired information patterns on the respective color-developing structural layers forming the specific recording layer utilizing the action of two-photon absorption, so that a quantity of recordable information can be increased to attain excellent visibility, and in turn far excellent security.

The specific recording layer is provided as a layer having the specific multi-layer structure, and the black color recording layer is laminated thereon, whereby information can be full color-indicated according to the so-called subtractive method by surely forming desired information patterns on the respective color-developing structural layers forming the specific recording layer and the black color recording layer utilizing the action of two-photon absorption for the specific recording layer and utilizing the action of absorption of a laser beam into the energy absorber for the black color recording layer, so that a quantity of recordable information can be more increased to attain far excellent visibility, and in turn farther excellent security.

According to the present invention, the cutting process that a sheet material is cut into individual card-forming regions may be conducted after personal informations are recorded on the specific multi-layer sheet material in the course of the production of the card type specific indicating materials, so that the production time required for the production of card type indicating materials can be shortened, and the quantity of the operation can be reduced compared with a conventional production process of card type indicating materials, in which recording of personal informations are conducted after a sheet material is cut into individual card-forming regions.

In the above, the present invention has been described on the basis of the specific embodiments. However, the present invention is not limited to these embodiments, and various changes or modifications may be added thereto.

### EXAMPLES

### Synthesis Example 1 of Diarylethene Derivative: (Synthesis of Cyan Color-Developing Component)

### (1) Synthesis of 3,5-dibromo-2-methoxythiophene

A carbon tetrachloride solution (250 mL) of N-bromosuccinimide (51 g, 290 mmol) was gradually added to a carbon tetrachloride solution (40 mL) of 2-methoxythiophene (16 g, 145 mmol) in an ice water bath. After the water bath was removed to stir the resultant mixture overnight, the mixture was cooled in an ice water bath, and solids were filtered out by suction filtration. After the resultant filtrate was extracted with chloroform, the resultant extract was washed with an aqueous solution of sodium hydrogencarbonate and water and dried over magnesium sulfate. This magnesium sulfate was removed by filtration to concentrate the extract. Thereafter, the concentrated extract was developed and separated on a silica gel column with hexane to obtain a colorless liquid. The liquid was subjected to distillation under reduced pressure under conditions of a distillation temperature of 90° C. and a pressure of 8 mmHg to purify it, thereby obtaining 24.6 g of a reaction product with a yield of 62.3%.

The resultant reaction product was identified as 3,5-dibromo-2-methoxythiophene from the results of NMR analysis and mass spectrometry.

The result of ¹H-NMR analysis and the result of mass spectrometry are shown below.
◯¹H-NMR (200 MHz, CDCl₃, TMS): δ 3.93(s,3H) 6.75(s,1H)
◯MS m/z=270, 272, 274 (M⁺)

### (2) Synthesis of 3-bromo-2-methoxy-5-phenylthiophene

After a hexane solution (56 mL, 95 mmol) of n-butyllithium having a concentration of 15% was slowly added dropwise to an anhydrous tetrahydrofuran solution (250 mL) of 3,5-dibromo-2-methoxythiophene (24 g, 90 mmol) at a temperature of −60° C. or lower under an argon atmosphere, and the resultant mixture was stirred for 1 hour, tri-n-butyl borate (32 mL, 12 mmol) was additionally slowly added dropwise at a temperature of −60° C. or lower, and the resultant mixture was stirred for 2 hours. The temperature of the reaction system was returned to room temperature, an aqueous solution (90 mL) of sodium carbonate having a concentration of 20% by mass, iodobenzene (6.4 g, 90 mmol) and tetrakis(trisphenylphosphine). palladium (4.4 g, 0.36 mmol) were added, and the resultant mixture was refluxed at 70° C. for 5 hours. After the refluxed product was then extracted with ether, the extract was washed with saline solution and dried over magnesium sulfate. This magnesium sulfate was removed by filtration to concentrate the extract. Thereafter, the concentrated extract was developed and separated on a silica gel column with hexane to obtain 4.90 g of a colorless liquid with a yield of 59.1%.

The resultant colorless liquid was identified as 3-bromo-2-methoxy-5-phenylthiophene from the results of NMR analysis and mass spectrometry.

The result of ¹H-NMR analysis and the result of mass spectrometry are shown below.
◯¹H-NMR (400 MHz, CDCl₃, TMS): δ 4.00(s,3H) 6.98(s,1H), 7.2-7.5(m,5H)
◯MS m/z=268, 270 (M⁺)
◯Anal. Calcd for C₁₁H₉BrOS: C, 49.09; H, 3.37 ◯Found: C, 49.20; H, 3.38

### (3) Synthesis of 1,2-bis(2-methoxy-5-phenylthiophen-3-yl) perfluorocyclopentene

After a hexane solution (36 mL, 57 mmol) of n-butyllithium having a concentration of 15% was slowly added dropwise to an anhydrous tetrahydrofuran solution (140 mL) of 3-bromo-2-methoxy-5-phenylthiophene (14 g, 52 mmol) at a temperature of −60° C. or lower under an argon atmosphere, and the resultant mixture was stirred for 1 hour, an anhydrous tetrahydrofuran solution (10 mL) of perfluorocyclopentene (3.5 mL, 26 mmol) was additionally slowly added dropwise, and the resultant mixture was stirred for 2 hours, and methanol was added to quench the resultant mixture. Thereafter, the mixture was washed with 1N hydrochloric acid and extracted with ether, and the resultant organic layer was washed with water and dried over magnesium sulfate. This magnesium sulfate was removed by filtration to concentrate the organic layer. The concentrated organic layer was developed and separated on a silica gel column with a mixed solvent (mass ratio; hexane:chloroform=9:1) of hexane and chloroform, thereby isolating 7.23g of the intended product with a yield of 50%.

The resultant reaction product was identified as 1,2-bis(2-methoxy-5-phenylthiophen-3-yl) perfluorocyclopentene (hereinafter also referred to as “diarylethene derivative (1)”) from the results of NMR analysis and mass spectrometry.

The result of ¹H-NMR analysis and the result of mass spectrometry are shown below.
◯¹H-NMR (400 MHz, CDCl₃, TMS): δ 3.71(s,3H) 7.15(s,1H), 7.2-7.5(m,5H)
◯MS m/z=552 (M⁺)
◯Anal. Calcd for C₂₇H₁₈F₆O₂S₂: C, 58.69; H, 3.28
◯Found: C, 58.87; H, 3.29

A colorless solution obtained by dissolving the resultant diarylethene derivative (1) in hexane was irradiated with ultraviolet light. As a result, it was confirmed that the derivative develops a cyan color.

Absorption spectra of the resultant diarylethene derivative (1) before and after the irradiation with ultraviolet light were measured. The results are shown in FIG. 5.

In FIG. 5, the absorption spectrum atlas before the irradiation with ultraviolet light is indicated by a curve (A), while the absorption spectrum atlas after the irradiation with ultraviolet light is indicated by a curve (B).

### Synthesis Example 2 of Diarylethene Derivative: (Synthesis of Magenta Color-Developing Component)

### (1) Synthesis of N-benzoylglycine Methyl Ester

After triethylamine (300 mL) was added to a chloroform solution (200 mL) of glycine methyl ester hydrochloride (15 g, 0.119 mol), benzoyl chloride (16.7 g, 0.119 mol) was gradually added dropwise while cooling in an ice bath. Thereafter, the resultant mixture was stirred for 2 hours at room temperature. The reaction mixture was extracted with chloroform, the resultant extract was washed with a 5% aqueous solution of acetic acid and water, and an organic layer was then dried over magnesium sulfate. This magnesium sulfate was removed by filtration to concentrate the organic layer. The concentrated organic layer was developed and separated on a silica gel column with ethyl acetate, thereby obtaining 18.5 g of a reaction product with a yield of 80.4%.

The resultant reaction product was identified as N-benzoylglycine methyl ester.

The result of ¹H-NMR analysis and the result of mass spectrometry are shown below.
◯¹H-NMR (400 MHz, CDCl₃, TMS): δ 3.81(s,3H) 4.26(d,2H,J=5.2 Hz), 6.67(broad,1H), 7.43-7.55(m,3H), 7.80-7.84(m,2H)
◯MS m/z=193 (M⁺)

### (2) Synthesis of 5-methoxy-2-phenylthiazole

N-Benzoylglycine methyl ester (1.0 g, 5.2 mmol) and an anhydrous chloroform solution (15 mL) of diphosphorus pentasulfide (1.4 g, 6.4 mmol) were refluxed for 24 hours at 80° C. under a nitrogen atmosphere, and water was added to terminate the reaction. Formed precipitate was dissolved in a strong alkaline aqueous solution and then extracted with dichloromethane, and the resultant organic layer was dried over magnesium sulfate. After this magnesium sulfate was removed by filtration, the solvent was distilled off. The resultant residue was developed and separated on a silica gel column with a mixed solvent (mass ratio; ethyl acetate:hexane=5:5) of ethyl acetate and hexane, thereby obtaining 556 mg of a reaction product with a yield of 57%.

The resultant reaction product was identified as 5-methoxy-2-phenylthiazole from the results of NMR analysis and mass spectrometry.

The result of ¹H-NMR analysis and the result of mass spectrometry are shown below.
◯¹H-NMR (200 MHz, CDCl₃): δ 7.84-7.80(m,2H,Ph), 7.60-7.40(m,3H,Ph), 6.65(br s,1H,NH), 4.27(d,J=4.8 Hz,2H,CH₂), 3.82(s,3H,OMe)
◯MS (EI⁺) m/z 191 (M⁺)
◯Anal. Calcd for C₁₀H₉NOS: C, 62.80; H, 4.74; N, 7.32
◯Found: C, 62.64; H, 4.78; N, 7.34

### (3) Synthesis of 4-bromo-5-methoxy-2-phenylthiazole

After N-bromosuccinimide (450 mg, 2.51 mmol) was added to an anhydrous chloroform solution (10 mL) of 5-methoxy-2-phenylthiazole (400 mg, 2.1 mmol) at 0° C., and the resultant mixture was stirred for 1 hour, stirring was additionally conducted for 3 hours at room temperature, and water was added to terminate the reaction. Extraction was conducted with ethyl acetate, and the resultant organic layer was dried over magnesium sulfate. After this magnesium sulfate was removed by filtration, the solvent was distilled off. The resultant residue was developed and separated on a silica gel column with a mixed solvent (mass ratio; ethyl acetate:hexane=1:3) of ethyl acetate and hexane, thereby obtaining 566 mg of a reaction product with a yield of 97%.

The resultant reaction product was identified as 4-bromo-5-methoxy-2-phenylthiazole from the results of NMR analysis and mass spectrometry.

The result of ¹H-NMR analysis and the result of mass spectrometry are shown below.
◯¹H-NMR (200 MHz, CDCl₃): δ 7.85-7.78(m,2H) , 7.45-7.36(m,3H), 4.03(s,3H)
◯MS(EI⁺) m/z 271 (M⁺)
◯Anal. Calcd for C₁₀H₈BrNOS: C, 44.46; H, 2.98; N, 5.18
◯Found: C, 44.56; H, 2.99; N. 5.19

### (4) Synthesis of 1-(5-methoxy-2-phenylthiazol-4-yl)-perfluorocyclopentene

An anhydrous tetrahydrofuran solution (5 mL) of 4-bromo-5-methoxy-2-phenylthiazole (500 mg, 1.85 mmol) was cooled to −80° C. under an argon atmosphere, a 1.6 M hexane solution (1.22 mL, 1.94 mmol) of n-butyllithium was added dropwise, and the resultant mixture was stirred for 15 minutes. Thereafter, an anhydrous tetrahydrofuran solution (2 mL) of perfluorocyclopentene (0.40 mL, 2.0 mmol) was slowly added dropwise, the resultant mixture was stirred for 2.5 hours, and water was added to terminate the reaction. Extraction was conducted with ether, and the resultant organic layer was dried over magnesium sulfate. After this magnesium sulfate was removed by filtration, the solvent was distilled off. The resultant residue was developed and separated on a silica gel column with a mixed solvent (mass ratio; ethyl acetate:hexane=1:3) of ethyl acetate and hexane, thereby obtaining 510 mg of a reaction product with a yield of 72%.

The resultant reaction product was identified as 1-(5-methoxy-2-phenylthiazol-4-yl)perfluoro-cyclopentene from the results of NMR analysis and mass spectrometry.

The result of ¹H-NMR analysis and the result of mass spectrometry are shown below.
◯¹H-NMR (200 MHz, CDCl₃): δ 7.88-7.82(m,2H), 7.48-7.40(m,3H), 4.13(s,3H)
◯MS (EI⁺) m/z 383 (M⁺)
◯Anal. Calcd for C₁₅H₈F₇NOS: C, 47.00; H, 2.10; N, 3.65
◯Found: C, 47.25; H, 2.08; N, 3.66

### (5) Synthesis of 1,2-bis(5-methoxy-2-phenylthiazol-4-yl)perfluorocyclopentene

An anhydrous tetrahydrofuran solution (8 mL) of 4-bromo-5-methoxy-2-phenylthiazole (540 mg, 2.00 mmol) was cooled to −80° C. under an argon atmosphere, a 1.6 M hexane solution (1.30 mL, 2.10 mmol) of n-butyllithium was added dropwise, and the resultant mixture was stirred for 15 minutes. Thereafter, an anhydrous tetrahydrofuran solution (2 mL) of 1-(5-methoxy-2-phenylthiazol-4-yl)perfluorocyclopentene (510 mg, 1.33 mmol) was slowly added dropwise, the resultant mixture was stirred for 2.5 hours, and water was added to terminate the reaction. Extraction was conducted with ether, and the resultant organic layer was dried over magnesium sulfate. After this magnesium sulfate was removed by filtration, the solvent was distilled off. The resultant residue was developed and separated on a silica gel column with a mixed solvent (mass ratio; ethyl acetate:hexane=3:7) of ethyl acetate and hexane, thereby obtaining 540 mg of a reaction product with a yield of 68%.

The resultant reaction product was identified as 1,2-bis(5-methoxy-2-phenylthiazol-4-yl)perfluoro-cyclopentene (hereinafter also referred to as “diarylethene derivative (2)”) from the results of NMR analysis and mass spectrometry.

The result of ¹H-NMR analysis and the result of mass spectrometry are shown below.
◯¹H-NMR (200 MHz, CDCl₃): δ 7.84-7.74(m,2H), 7.44-7.35(m,3H), 3.84(s,3H)
◯MS(EI⁺) m/z 554 (M⁺)
◯nal. Calcd for C₂₅H₁₆F₆N₂O₂S₂: C, 54.15; H, 2.91; N, 5.05
◯Found: C, 54.25; H, 2.97; N, 5.10

A colorless solution obtained by dissolving the resultant diarylethene derivative (2) in hexane was irradiated with ultraviolet light. As a result, it was confirmed that the derivative develops a magenta color.

Absorption spectra of the resultant diarylethene derivative (2) before and after the irradiation with ultraviolet light were measured. The results are shown in FIG. 6.

In FIG. 6, the absorption spectrum atlas before the irradiation with ultraviolet light is indicated by a curve (A), while the absorption spectrum atlas after the irradiation with ultraviolet light is indicated by a curve (B).

### Synthesis Example 3 of Diarylethene Derivative (Synthesis of Yellow Color-Developing Component)

### (1) Synthesis of 5-methoxy-2-phenyloxazole

After 70 g of phosphorus oxide (P₂O₅) was added to an anhydrous chloroform solution (200 mL) of N-benzoylglycine methyl ester (18 g, 93.1 mmol), and the resultant mixture was refluxed for 48 hours, the resultant reaction mixture was added to an aqueous solution (200 mL) of sodium hydroxide having a concentration of 10% while cooling in an ice bath, extraction was conducted with chloroform, and the resultant organic layer was dried over magnesium sulfate. This magnesium sulfate was removed by filtration to concentrate the organic layer. Thereafter, the concentrated organic layer was developed and separated on a silica gel column with chloroform to obtain 14.5 g of a reaction product with a yield of 89%.

The resultant reaction product was identified as 5-methoxy-2-phenyloxazole from the results of NMR analysis and mass spectrometry.

The result of ¹H-NMR analysis and the result of mass spectrometry are shown below.
◯¹H-NMR (400 MHz, CDCl₃, TMS): δ 3.95(s,3H) 6.21(s,1H), 7.38-7.43(m,3H), 7.90-7.93(m,2H)
◯MS m/z=175 (M⁺)

### (2) Synthesis of 4-bromo-5-methoxy-2-phenyloxazole

After N-bromosuccinimide (14.2 g, 79.9 mmol) was added to an acetonitrile solution (300 mL) of 5-methoxy-2-phenyloxazole (14 g, 79.9 mmol), and the resultant mixture was stirred for 30 minutes at room temperature, an aqueous hypo solution was added to the resultant reaction solution, and extraction was conducted with ether. The resultant organic layer was washed with saline solution and dried over magnesium sulfate. This magnesium sulfate was removed by filtration to concentrate the organic layer. Thereafter, the concentrated organic layer was developed and separated on a silica gel column with a mixed solvent (mass ratio; hexane:ethyl acetate=9:1) of hexane and ethyl acetate, thereby obtaining 6.87 g of a reaction product with a yield of 34%.

The resultant reaction product was identified as 4-bromo-5-methoxy-2-phenyloxazole from the results of NMR analysis and mass spectrometry.

The result of ¹H-NMR analysis and the result of mass spectrometry are shown below.
◯¹H-NMR (400 MHz, CDCl₃, TMS): δ 4.11(s,3H), 7.42-7.45(m,3H), 7.90-7.93(m,2H)
◯MS m/z=253, 255 (M⁺)

### (3) Synthesis of 1,2-bis(5-methoxy-2-phenyloxazol-4-yl)perfluorocyclopentene

After an anhydrous tetrahydrofuran solution (40 mL) of 4-bromo-5-methoxy-2-phenyloxazole (4 g, 15.7 mmol) was cooled to −78° C. under an argon atmosphere, a hexane solution (10 mL, 16.5 mmol) of n-butyllithium having a concentration of 15% was gradually added dropwise, and the resultant mixture was stirred for 30 minutes. Thereafter, an anhydrous tetrahydrofuran solution (5 mL) of octafluoro-cyclopentene (1.0 mL, 7.85 mmol) was slowly added dropwise, the resultant mixture was stirred for 1 hour, and water was added to terminate the reaction. Extraction was conducted with ether, and the resultant organic layer was washed with a saturated saline solution and dried over magnesium sulfate. This magnesium sulfate was removed by filtration to concentrate the organic layer. The concentrated organic layer was developed and separated on a silica gel column with a mixed solvent (mass ratio; chloroform:hexane=1:1) of chloroform and hexane, thereby obtaining 500 mg of a reaction product with a yield of 12%.

The resultant reaction product was identified as 1,2-bis(5-methoxy-2-phenyloxazol-4-yl)perfluoro-cyclopentene (hereinafter also referred to as “diarylethene derivative (3)”) from the results of NMR analysis and mass spectrometry.

The result of ¹H-NMR analysis and the result of mass spectrometry are shown below.
◯¹H-NMR (400 MHz, CDCl₃, TMS): δ 4.03(s,3H), 7.41-7.43(m,3H), 7.90-7.93(m,2H)
◯MS m/z=522 (M⁺)

A colorless solution obtained by dissolving the resultant diarylethene derivative (3) in hexane was irradiated with ultraviolet light. As a result, it was confirmed that the derivative develops a yellow color.

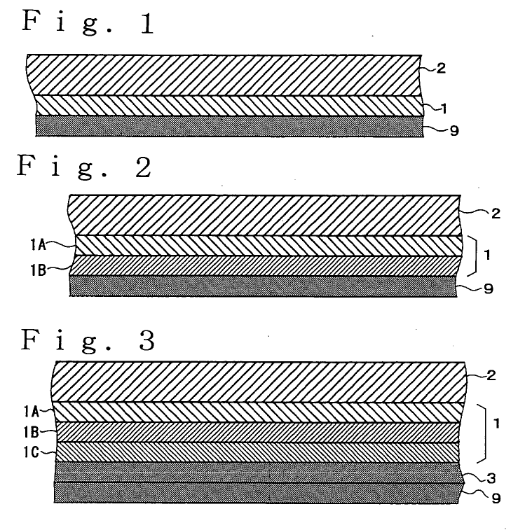

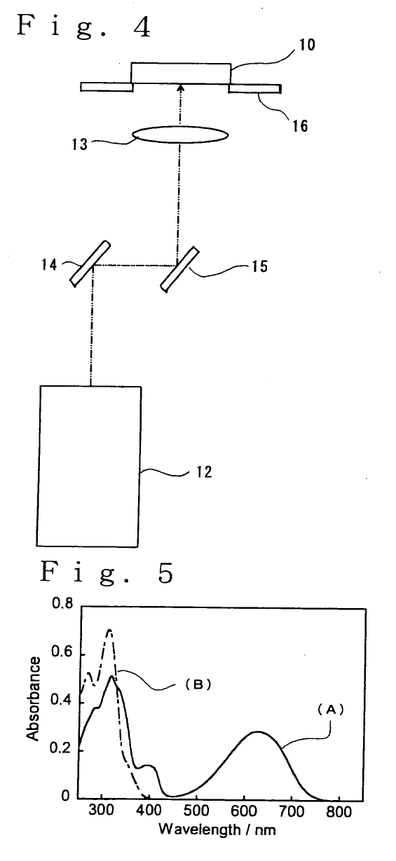

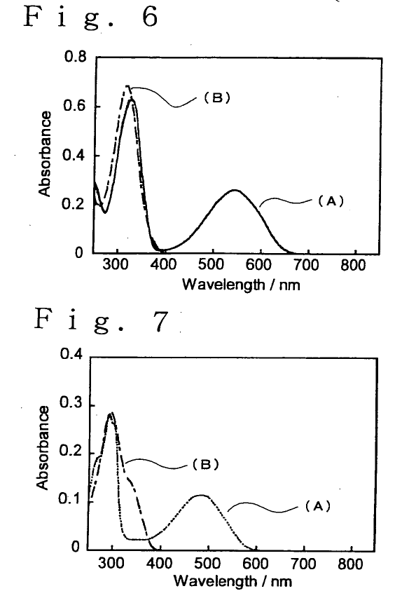

Absorption spectra of the resultant diarylethene derivative (3) before and after the irradiation with ultraviolet light were measured. The results are shown in FIG. 7.

In FIG. 7, the absorption spectrum atlas before the irradiation with ultraviolet light is indicated by a curve (A), while the absorption spectrum atlas after the irradiation with ultraviolet light is indicated by a curve (B).

### Preparation Example of Resin Binder

A glass-made pressure bottle having a volume of 100 ml was charged with 45 g (489 mmol) of toluene having a water content of 10 ppm, 40 mmol of 5-butylbicyclo[2.2.1]hept-2-ene and 50 mmol of bicyclo[2.2.2]hept-2-ene, the charging opening of the pressure bottle was sealed with a crown rubber cap, and 30 ml (0.1 MPa) of gaseous ethylene as a molecular weight modifier was further charged through the rubber cap. This pressure bottle was heated to 55° C., and palladium acetate in an amount of 2×10⁻⁴ mg in terms of a Pd atom, 2×10⁻⁴ mmol of tricyclohexylphosphine and 2×10⁻⁴ mmol of triphenylcarbenium tetrakispentafluorophenyl borate ([Ph₃C.B(C₆F₆)₄]) were added in this order to start a polymerization reaction.

The polymerization was conducted under conditions of a temperature of 55° C. and a reaction time of 5 hours. Upon elapsed times of 1.5 hours and 3.5 hours after the polymerization was started, each 5 mmol of bicyclo[2.2.1]hept-2-ene was added, and 4×10⁻⁴ mmol of triethylamine was then added to terminate the polymerization reaction. It was confirmed from the gas chromatographic analysis of remaining monomers in the resultant polymer solution that a conversion is 99.8%, and a structural unit derived from 5-butyl-bicyclo[2.2.1]hept-2-ene in the copolymer is 39.5 mol %.

The polymer solution was poured into 2 liters of isopropanol to solidify the copolymer. The resultant solidified product was dried for 17 hours under reduced pressure under conditions of 90° C., thereby obtaining a copolymer (hereinafter also referred to as “transparent resin (1)”) of 5-butylbicyclo[2.2.1]-hept-2-ene and bicyclo[2.2.1]hept-2-ene, which had a number average molecular weight (Mn) of 56,000 in terms of polystyrene and a weight average molecular weight (Mw) of 168,000 in terms of polystyrene.

### Preparation Example of Sheet Material for Cyan Color-Developing Structural Layer

In a yellow room, 100 parts by weight of the transparent resin (1) and 2 parts by weight of the diarylethene derivative (1) were dissolved and mixed in toluene, and the resultant liquid was used to form a film by a solvent casting process. The film was dried at 150° C. for 180 minutes, thereby obtaining a sheet material (hereinafter also referred to as “sheet material (1) for cyan color-developing structural layer”) having a thickness of 60 μm.

### Preparation Example of Sheet Material for Magenta Color-Developing Structural Layer

A sheet material (hereinafter also referred to as “sheet material (1) for magenta color-developing structural layer”) having a thickness of 60 μm was obtained in the same manner as in Preparation Example of sheet material for cyan color-developing structural layer except that the diarylethene derivative (2) was used in place of the diarylethene derivative (1).

### Preparation Example of Sheet Material for Black Color-Developing Layer

One hundred parts by mass of a polycarbonate resin “Toughlon A2600” (product of Idemitsu Petrochemical Co., Ltd.), 100 parts by mass of calcium carbonate “Luminal DSN-30” (product of NEMOTO & CO., LTD.), 0.1 part by mass of titanium oxide “CR60-2” (product of Ishihara Sangyo, Ltd.), 0.01 part by mass of carbon black “#45” (product of Mitsubishi Chemical Corporation) and 1 part by mass of a dispersing agent “EB-F” (product of Nippon Oil & Fats Co., Ltd.) were mixed in a mixer, and this mixture was pelletized by a pelletizer. The resultant pellets were used as a forming material to obtain a sheet material (hereinafter also referred to as “sheet material (1) for black color-developing layer”) having a thickness of 60 μm by means of an extruder.

### Production Example 1 of Indicating Material: (Production of Specific Single Color Indicating Material)

A sheet material (hereinafter also referred to as “ultraviolet light-screening sheet material”) for ultraviolet light-screening layer having visible light-transmitting ability with 2.5 parts by mass of an ultraviolet light absorber “A-31” (product of Asahi Denka Kogyo K.K.) added to a cycloolefin resin “ARTON D5000” (product of JSR CORPORATION) was provided in a yellow room, the sheet material (1) for cyan color-developing structural layer was laminated on this ultraviolet light-screening sheet material, and bubbles produced in a lamination interface were pressed out by means of a roll, thereby obtaining a laminated material of a structure that the ultraviolet light-screening layer composed of the ultraviolet light-screening sheet material and a specific recording layer composed of the cyan color-developing structural layer are laminated.

In a yellow room, the thus-obtained laminated material was irradiated with ultraviolet light from a side opposite to the surface laminated on the ultraviolet light-screening layer in the recording layer under conditions of a spot size of 0.15 mm and a scan speed of 1 m/sec by means of an optical forming apparatus “SCR8000” (laser-wavelength: 355 nm, laser power: 800 mW, manufactured by T-MECK CO., LTD.) to visually observe the laminated material. As a result, a patterned portion irradiated with the ultraviolet light developed a cyan color.

An opaque base sheet material “DT-J 271G” (product of Toyo Ink Mfg. Co., Ltd.) (hereinafter also referred to as “sheet material for opaque base layer”) having ultraviolet light-screening ability was laminated on the specific recording layer of the laminated material having the cyan color-developed patterned portion, and bubbles produced in a lamination interface were pressed out by means of a roll, thereby producing an indicating material (hereinafter also referred to as “indicating material (1)”) of a structure that the opaque base layer, the specific recording layer composed of the cyan color-developing structural layer, and ultraviolet light-screening layer are laminated.

After the thus-produced indicating material (1) was left to stand for 2 weeks at a position about 2 m away from a fluorescent lamp under the fluorescent lamp in a room, the appearance thereof was visually observed. As a result, no fading was observed on the cyan color-developed patterned portion, and no color development was observed on another portion than the cyan color-developed patterned portion.

### Production Example 2 of Indicating Material: (Production of Specific Single Color Indicating Material)

An laminated material of a structure that the ultraviolet light-screening layer composed of the ultraviolet light-screening sheet material and a specific recording layer composed of a magenta color-developing structural layer are laminated was obtained in the same manner as in Production Example 1 of indicating material except that the sheet material (1) for magenta color-developing structural layer was used in place of the sheet material (1) for cyan color-developing structural layer. In a yellow room, the thus-obtained laminated material was irradiated with ultraviolet light from a side opposite to the surface laminated on the ultraviolet light-screening layer in the recording layer under conditions of a spot size of 0.15 mm and a scan speed of 1 m/sec by means of an optical forming apparatus “SCR8000” (laser wavelength: 355 nm, laser power: 800 mW, manufactured by T-MECK CO., LTD.) to visually observe the laminated material. As a result, a patterned portion irradiated with the ultraviolet light developed a magenta color.

A sheet material for opaque base layer was laminated on the specific recording layer of the laminated material having the magenta color-developed patterned portion, and bubbles produced in a lamination interface were pressed out by means of a roll, thereby producing an indicating material (hereinafter also referred to as “indicating material (2)”) of a structure that the opaque base layer, the specific recording layer composed of the magenta color-developing structural layer, and ultraviolet light-screening layer are laminated.

After the thus-produced indicating material (2) was left to stand for 2 weeks at a position about 2 m away from a fluorescent lamp under the fluorescent lamp in a room, the appearance thereof was visually observed. As a result, no fading was observed on the magenta color-developed patterned portion, and no color development was observed on another portion than the magenta color-developed patterned portion.

### Production Example 3 of Indicating Material: (Production of Specific Black Color Indicating Material)

In a yellow room, an ultraviolet light-screening sheet material was provided, the sheet material (1) for cyan color-developing structural layer was laminated on this ultraviolet light-screening sheet material, the sheet material (1) for magenta color-developing structural layer was laminated on the sheet material (1) for cyan color-developing structural layer, the sheet material (1) for black color-developing layer was further laminated on the sheet material (1) for magenta color-developing structural layer, and bubbles produced in lamination interfaces were pressed out by means of a roll, thereby obtaining a laminated material (hereinafter also referred to as “indicating material (3)”) of a structure that the ultraviolet light-screening layer composed of the ultraviolet light-screening sheet material and a specific recording layer composed of the cyan color-developing structural layer and the magenta color-developing structural layer, the black color recording layer composed of the black color-developing layer also having a function as an ultraviolet light-screening layer and a function as an opaque base layer are laminated.

In the thus-obtained indicating material (3), the magenta color-developing structural layer in the specific recording layer was first irradiated with a laser beam having a wavelength of 763 nm from a side of the ultraviolet light-screening layer by means of an apparatus equipped with a femtoseconds laser “Mai Tai” (oscillation wavelength: variable wavelength of 710-990 nm, power: 1.5 W, manufactured by Spectra-Physics Inc.) as a two-photon laser beam source to visually observe the magenta color-developing structural layer. As a result, a patterned portion irradiated with the laser beam developed a magenta color, and the cyan color-developing structural layer was also visually observed. As a result, it did not develop a color. The cyan color-developing structural layer in the specific recording layer was then irradiated with a laser beam having a wavelength of 810 nm to visually observe the cyan color-developing structural layer. As a result, a patterned portion irradiated with the laser beam developed a cyan color, and the magenta color-developing structural layer was also visually observed. As a result, no newly color-developed portion was found.

The indicating material (3) was further irradiated with a laser beam from a side (side opposite to the ultraviolet light-screening layer) of the black color-developing layer by means of a YAG laser (oscillation wavelength: 1,065 nm, manufactured by NEC Corporation) to visually observe the indicating material (3). As a result, a patterned portion irradiated with the laser beam developed a black color, and the cyan color-developing structural layer and the magenta color-developing structural layer were also visually observed. As a result, no newly color-developed portion was found.

After the thus-produced indicating material (3) was left to stand for 2 weeks at a position about 2 m away from a fluorescent lamp under the fluorescent lamp in a room, the appearance thereof was visually observed. As. a result, no fading was observed on the cyan, magenta and black color-developed patterned portions, and no color development was observed on any other portion than the cyan, magenta and black color-developed patterned portions.

1. An indication material comprising a structure that an ultraviolet light-screening layer having visible light-transmitting ability is laminated on a recording layer having visible light-transmitting ability and composed of a recording layer-forming material containing a color-developing component that becomes a color-developed state by the action of ultraviolet light.

2. The indication material according to claim 1, wherein the color-developing component making up the recording layer is substantially not faded from the color-developed state by the action of visible light.

3. The indicating material according to claim 1, wherein the color-developing component making up the recording layer is composed of a diarylethene derivative.

4. The indicating material according to claim 1, wherein the recording layer is composed of at least one of a yellow color-developing structural layer which develops a yellow color, a magenta color-developing structural layer which develops a magenta color, and a cyan color-developing structural layer which develops a cyan color.

5. The indicating material according to claim 4, which comprises a recording layer composed of a plurality of color-developing structural layers, and wherein the plurality of the color-developing structural layers contain respective color-developing components that each become a color-developed state by the action of ultraviolet light having the same wavelength.

6. The indicating material according to claim 4, which comprises a recording layer composed of a plurality of color-developing structural layers, and wherein the plurality of the color-developing structural layers contain respective color-developing components that become a color-developed state by the action of ultraviolet light having different wavelengths.

7. The indicating material according to claim 1, which has a structure that the ultraviolet light-screening layer is laminated on one surface of the recording layer, and a black color recording layer which develops a black color, is laminated on the other surface of the recording layer.

8. The indicating material according to claim 1, which has a structure that the ultraviolet light-screening layer is laminated on one surface of the recording layer, and an opaque base layer is laminated on the other surface of the recording layer.

9. An indicating method for recording and indicating information on the indicating material according to claim 1, which comprises:
condensing a laser beam having a wavelength of a visible range or longer on the recording layer in the indicating material to irradiate the recording layer with the laser beam and recording and indicating the information by two-photon absorption.

10. The indicating method according to claim 9 for recording and indicating information on the indicating material which comprises the step of:
conducting condensing and irradiation of the laser beam on at least one color-developing structural layer of the yellow color-developing structural layer, the magenta color-developing structural layer and the cyan color-developing structural layer, which form the recording layer.

11. An indicating method for recording and indicating information on the indicating material according to claim 4 of the structure having the recording layer composed of at least one color-developing structural layer of the yellow color-developing structural layer, the magenta color-developing structural layer and the cyan color-developing structural layer, which comprises
irradiating the recording layer of the indicating material with light having a wavelength of 400 nm or shorter from a side opposite to the surface laminated on the ultraviolet light-screening layer in the recording layer, thereby recording and indicating the information.

12. An indicating method for recording and indicating information on the indicating material according to claim 7, which comprises
irradiating the black color recording layer in the indicating material with light having a wavelength of 500 nm or longer, thereby recording and indicating the information.
